(19) United States
(12) Patent Application Publication
(10) Pub. No.: US 2006/0002275 A1
(43) Pub. Date: Jan. 5, 2006

(54) Optical head

(76) Inventors: Chun-Chieh Huang, Hsinchu (TW); Chen-I Kuo, Hsinchu (TW); Hsiang-Chieh Yu, Hsinchu (TW); Jau-Jiu Ju, Hsinchu (TW); Chi-Lone Chang, Hsinchu (TW); Yuan-Chin Lee, Hsinchu (TW); Chau-Yuan Ke, Hsinchu (TW)

Correspondence Address: RABIN & BERDO, P.C., Suite 500, 1101 14 Street, N.W., Washington, DC, 20005, US

(21) Appl. No.: 11/074,731

(22) Filed: Mar. 9, 2005

(30) Foreign Application Priority Data
Jul. 2, 2004 (TW) 93120006

(51) Int. Cl. G11B 7/00

(52) U.S. Cl. 369/112.01; 369/112.28

(57) ABSTRACT

An optical head to access data on an optical recording medium, which has two data storage densities, includes two sets of optical path systems to provide two optical paths that are crossed. Each optical path system includes a laser light generation unit, a light guiding unit, a converging objective lens and a photo detector. The light guiding unit is located on the optical path of the laser light generation unit, to direct the laser light to pass through the converging objective lens and focus on the data side of the optical recording medium to carry optical data signals from the data side. The laser light returns to the light guiding unit and travels along the optical path and is received by the photo detector.

### FIELD OF THE INVENTION

The present invention relates to an optical head and particularly to an optical head that has dual optical paths.

### BACKGROUND OF THE INVENTION

Using an optical head to access data on an optical recording medium is a technique known in the art. While the storage capacity and density of the optical recording medium has increased gradually, the structure of the optical head has also improved. One of the advanced features is that the wavelength of laser light to access the optical recording medium becomes shorter, and the numerical aperture (NA) of the objective lens gradually increases (i.e. the converging focal point of the laser light to access the optical recording medium becomes smaller, its size is in direct proportion with the wavelength of the laser light, but is in inverse proportion with the NA of the objective lens) to respond to the increasing storage capacity and density of the optical recording medium.

The new type of optical head has to be inversely compatible. Namely, it must be able to access new types of optical recording media and also has to access the older types of optical recording media. Hence the new type of optical head has to equip with a read/write mechanism for laser light of different wavelengths. As a result, optical recording media capable of storing data of two different densities have been developed. For instance, now many optical heads can read/write a Compact Disk (CD) and a Digital Versatile Disk (DVD).

One example is U.S. Pat. No. 5,446,565, which discloses a dual focal points converging objective lens that can form different NA of the objective lens. When a laser light generation unit generates laser light, which travels to a holographic optical element (HOE), the laser light forms diffraction because of the HOE, and the converging objective lens focuses the light on an optical recording medium. Using the characteristics of the HOE that can form two diffraction angles, and is coupled with the converging objective lens, the laser light may be converged to different foal points (the data surface of the optical recording medium that has different data storage densities) to access the optical recording medium that has two different data storage densities. However, the HOE is more expensive in fabrication.

Based on cost consideration, employing two light sources and two objective lenses is a more economic choice. Korea patent No. 00255233 discloses a technique that uses laser light of two different wavelengths to couple with different lenses to provide different focal points and read optical spots of different diameters. The optical head allows laser lights of different wavelengths generated by two laser light generation units to travel their own optical paths to reach the converging objective lens. And according to different NA of the objective lens corresponding to the laser light of different wavelengths, different sizes of focal points are formed. After reflected by the optical recording medium, each travels back to its own photo detector, thereby can access the optical recording medium that has two different data storage densities. But the dual optical paths system significantly increases the size of the whole device. This is against the prevailing requirements of 3C products.

### SUMMARY OF THE INVENTION

In view of the aforesaid disadvantages occurring to conventional techniques, the primary object of the present is to provide an optical head that has dual optical paths to access data on an optical recording medium, having two different data storage densities and reducing the size of the optical head.

The optical head that has dual optical paths according to the invention aims to read/write an optical recording medium that has different data storage densities. It consists of two sets of optical path systems. Each optical path system includes a laser light generation unit, a light guiding unit, a converging objective lens and a photo detector. The two laser light generation units generate laser lights of different wavelengths. The light guiding unit is located on the optical path of the laser light generation unit to direct the laser light generated by the laser light generation unit to travel, and pass through the converging objective lens, and focus on the data side of the optical recording medium. The focused laser light is reflected on the optical recording medium and carries optical data signals recorded on the data side, and returns to the light guiding unit along the optical path, to be received by the photo detector for transforming to corresponding electric signals. The optical paths of the two optical path systems are crossed to shrink the total size of the optical head.

The present invention further includes an optical head, which has an actuator for holding the two optical path systems. It includes an objective lens holding seat, a focus coil, a track coil, a magnetic path device and a plurality of metal wires. The converging objective lenses of the two optical path systems are located on the topside of the objective lens holding seat. The focus coil is located on the objective lens holding seat and has the inductive magnetic direction coincided with the focusing direction of the converging objective lens. The track coil is located on the objective lens holding seat and has the inductive magnetic direction normal to the focusing direction to serve as the track direction. The magnetic path device generates a magnetic field in a direction parallel with the inductive magnetic field of the track coil and normal to inductive magnetic field direction of the focus coil. The metal wires aim to brace the objective lens holding seat and enable the objective lens holding seat to be movable in the focusing direction and the track direction.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic view of an embodiment of the present invention.

FIG. 2 is a schematic view of an embodiment of the actuator of the present invention.

### DESCRIPTION OF THE PREFERRED EMBODIMENTS

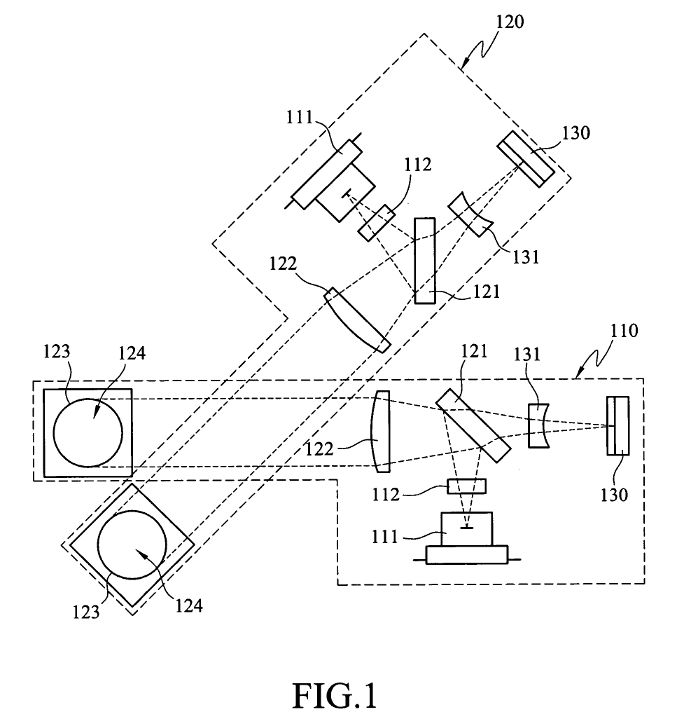

The optical head of multiple wavelengths according to the present invention aims to access data on an optical recording medium that has different data storage densities. Refer to FIG. 1 for an embodiment of the invention. It includes a first optical path system 110 and a second optical path system 120 that are crossed to reduce the size of the optical head.

The first optical path system 110 and the second optical path system 120 include respectively a laser light generation unit, a light guiding unit, a converging objective lens (not shown in the drawing) and a photo detector 130. The laser light generation unit includes a laser diode 111 and a diffraction grating 112. The laser diode 11 emits a linear polarized laser light. The diffraction grating 112 changes the emitted laser light into a laser light for reading and tracking.

The light guiding unit is located on the optical path of the laser light generation unit, for direct traveling of the laser light generated by the laser light generation unit and passing through the converging objective lens and focusing on the data side of the optical recording medium. The focused laser light is reflected and returns to the light guiding unit along the optical path to be received by the photo detector 130 for transforming the optical data signals to corresponding electric signals. As shown in FIG. 1, the light guiding unit includes a beam-splitter 121, a collimator 122 and a folding mirror 123. The beam-splitter 121 first reflects the laser light generated by the laser light generation unit. The laser light passes through the collimator 122 to become parallel light, then reaches the folding mirror 123 to be directed to the converging objective lens 124. The laser light is converged by the converging objective lens 124 and focuses on the data side of the optical recording medium. The focused laser light is reflected on the optical recording medium, and passes along the optical path to the folding mirror 123, the collimator 122 and the beam-splitter 121, and finally is received by the photo detector 130. In this embodiment, a concave lens 131 is provided and located on the optical path before the laser light reaches the photo detector 130 to amend the optical signal quality reflected by the optical disk. By means of such a construction, the first optical path system 110 and the second optical path system 120 can read the optical recording medium that has two different data densities. The two optical paths cross at about 30 to 150 degrees to enable the whole space to be fully utilized.

For a data writing process on the optical recording medium, the optical path of the incident laser light and the reflection laser light is the same as the one of data reading previously discussed. The difference is that, in the writing process, a function generator is used to regulate the driving circuit of the laser light generation unit, so that the energy of laser light may be altered as desired. Through a photothermal effect, a physical change occurs to the material of the optical recording medium. According to the energy of the laser light, pits that represent the data of “0” or “1” are formed on the data storage surface of the optical recording medium. To make the optical head reading the data smoothly, the optical head actuator should be able to perform a parallel focus to allow the laser light passing through the objective lens, to focus accurately on the data recording layer of the disk. A parallel tracking characteristic is needed to keep the focal point in the center of the data track of the data recording layer of the data recording medium.

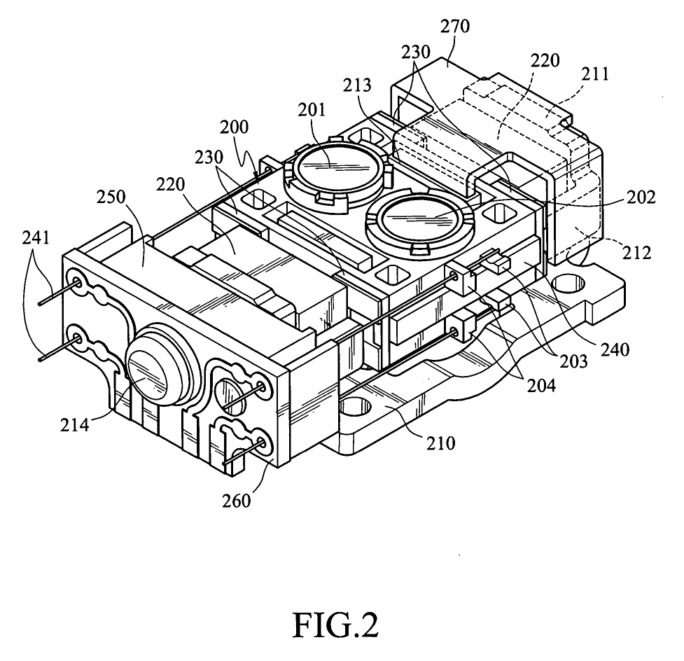

The optical head according to the invention further includes an actuator for holding the two optical path systems. Refer to FIG. 2 for an embodiment of the actuator of the invention. It includes a magnetic path device which includes of an objective lens holding seat 200, a focus coil 240, a track coil 230, a yoke 210 and a magnet 220, four metal wires 241, a damper holding dock 250 and a circuit board 260. The objective lenses 201 and 202 of the two optical path systems are located on the top side of the objective lens holding seat 200 in two openings formed thereon. The objective lens holding seat 200 has a plurality of first lugs 204 and second lugs 203 extended from a lateral side. Each of the first lugs 204 has a conical opening, to allow one metal wire 241 to pass through. The second lugs 203 are in contact with a distal end of the focus coil 240 or the track coil 230, to facilitate soldering of the coil and the metal wire 241. Thereby, the metal wires 241 can support the objective lens holding seat 200 and enable the objective lens holding seat 200 to be movable in focusing direction and track direction. The focus coil 240 is located on the objective lens holding seat 200 and has the inductive magnetic field direction coinciding with the focusing direction of the converging objective lenses 201 and 202. The track coil 230 is located on the objective lens holding seat 200 and has the inductive magnetic field direction normal to the focusing direction, to serve as the track direction.

The magnetic path device aims to generate a magnetic field. The direction of the magnetic field is parallel with the inductive magnetic field direction of the track coil and normal to the inductive magnetic field direction of the focus coil. In the embodiment shown in FIG. 2, the magnetic path device includes the yoke 210, and the magnet 220 attached to the yoke 210. The yoke 210 has one or more sidewalls 211 and one or more inner walls 213, corresponding to the sidewalls 211. The magnet 220 is attached to the side wall 211. The magnet 220, sidewall 211, inner wall 213 and the bottom of the yoke 210 that is clamped between the side wall 211 and the inner wall 213 jointly form the magnetic path set forth above. The sidewall 211 has two flanges 212 extended from two sides towards the magnet. The flanges 212 have a bending angle of about 10 to 120 degrees to direct the magnetic field linedistribution of the magnetic field. The yoke 210 has an arched bottom extending outwards for adjusting the inclination angle during installation. There is a damper holding dock 250 fastened to the yoke through a screw 214 such, that the damper holding dock 250 is turning about the screw 214 relative to the yoke 210 to adjust the inclination angle of the actuator during installation of the optical system. The circuit board 260 is coupled to the surface of the damper holding dock 250. The metal wires 241 are connected to the circuit board 260, to establish electric connection with the exterior. An upper lid 270 is provided to protect the movable elements against external impact and prevent the movable elements from moving outside the allowable range.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments, which do not depart from the spirit and scope of the invention.

What is claimed is:

1. An optical head for reading and writing an optical recording medium, which has two different data storage densities, comprising:
two sets of optical path systems each including:
a laser light generation unit to generate a laser light, the laser lights of the two optical path systems having different wavelengths;
a light guiding unit located on an optical path of the laser light generation unit for direct traveling of the laser light;
a converging objective lens to receive the laser light from the light guiding unit and focus the laser light on a data side of the optical recording medium; and
a photo detector to receive the laser light reflected from the optical recording medium to carry optical data signals of the data side and directed by the light guiding unit;
wherein the optical paths directed by the light guiding units of the two sets of optical path systems are crossed.

2. The optical head of claim 1, wherein the optical paths of the two sets of optical path systems cross at an angle between 30 to 150 degrees.

3. The optical head of claim 1, wherein the laser light generation unit includes a laser diode and a diffraction grating, the laser diode emitting the laser light, the diffraction grating dividing the laser light into an access laser light and a track laser light.

4. The optical head of claim 1, wherein the light guiding unit includes a beam-splitter, a collimator and a folding mirror, the beam-splitter reflecting the laser light generated by the laser light generation unit, to pass through the collimator to become a parallel light, and to reach the folding mirror to be directed to the converging objective lens for focusing on the data side of the optical recording medium, then to be reflected by the data side to the light guiding unit and to be received by the photo detector.

5. The optical head of claim 1 further including a concave lens on the optical path before the laser light enters the photo detector.

6. An optical head for reading and writing an optical recording medium which has two different data storage densities, comprising:
two sets of optical path systems for directing two laser lights to pass through two converging objective lenses and focus on a data side of the optical recording medium, the optical paths of the two laser lights being crossed;
an actuator for installing the two sets optical path systems, including:
an objective lens holding seat having a top side to hold the converging objective lens;
a focus coil located on the objective lens holding seat, having an inductive magnetic direction coinciding with the focusing direction of the converging objective lens;
a track coil, located on the objective lens holding seat having, an inductive magnetic direction normal to the focusing direction to serve as a track direction; and
a magnetic path device to generate a magnetic field, which has a direction parallel with the inductive magnetic direction of the track coil and is normal to the inductive magnetic direction of the focus coil, to produce reactions on the focus coil and the track coil;
a plurality of metal wires for bracing the objective lens holding seat such, that the objective lens holding seat is movable in the focusing direction and the track direction; and
an upper lid to prevent movable elements of the actuator from moving outside an allowable range and being impacted by external forces.

7. The optical head of claim 6, wherein the optical paths of the two sets of optical path systems cross at an angle between 30 to 150 degrees.

8. The optical head of claim 6, wherein the objective lens holding seat has a plurality of first lugs and second lugs extended from lateral sides, each of the first lugs having a conical opening to allow one of the metal wires to pass through, the second lugs being in contact with a distal end of the focus coil or the track coil.

9. The optical head of claim 6, wherein the magnetic path device includes an yoke and at least one magnet, the yoke having at least one side wall and one corresponding inner wall, the magnet being attached to the side wall to generate a magnetic field, the inner wall holding the objective lens holding seat on the yoke.

10. The optical head of claim 9, wherein the side wall has a flange extended respectively from two sides towards the magnet, the flange being bent at an angle of about 10 to 120 degrees to direct magnetic filed line distribution of the magnetic field.

11. The optical head of claim 9, wherein the yoke has an arched bottom extending outwards.

12. The optical head of claim 9, further having a damper holding dock fastened to the yoke through a screw such, that the damper holding dock is turning about the screw relative to the yoke to adjust the inclination angle.

13. The optical head of claim 9, further having a circuit board, coupled on the surface of the damper holding dock to connect to the metal wires electrically.
